(19) United States
(12) Patent Application Publication
(10) Pub. No.: US 2021/0181391 A1
(43) Pub. Date: Jun. 17, 2021

(54) A Field-Enhancing Device

(71) Applicants: Aalto University Foundation sr, Aalto (FI); Helsingin yliopisto, Helsingin yliopisto (FI)

(72) Inventors: Nagarajan Subramaniyam, Helsinki (FI); Markku SOPANEN, Helsinki (FI); Elina IKONEN, Helsinki (FI); Antti ISOMÄKI, Helsinki (FI); Simon PFISTERER, Helsinki (FI)

(73) Assignees: Aalto University Foundation sr, Aalto (FI); Helsingin yliopisto, Helsingin yliopisto (FI)

(21) Appl. No.: 16/761,813

(22) PCT Filed: Nov. 6, 2018
(86) PCT No.: PCT/FI2018/050816

§ 371 Date: May 6, 2020

(30) Foreign Application Priority Data
Nov. 6, 2017 (FI) 20175982

(51) Int. Cl. G02B 5/18; G02B 5/08; G02B 27/42

(52) U.S. Cl. CPC G02B 5/1861; G02B 27/425; G02B 5/085

(57) ABSTRACT

A field-enhancing device includes at least one metal layer or a metal grating consisting of metal stripes or a dielectric grating. Usually the device is constructed on some substrate. The adhesive layer is advantageous when the next layer is metallic but is not needed with dielectric layers. The next layers to be constructed form a mirror structure that can also be omitted for simple field-enhancing device constructs. The mirror structure can be either a metal mirror structure or a distributed Bragg reflector structure (DBR). The next layer is the thin metal layer. This layer can be covered with a 1-D metal grating consisting of metal stripes or with a dielectric grating having similar geometry. The structure can also be fabricated without metals when dielectric grating is used as the field-enhancing part. Finally, a protective layer can be added on top of the structure.

### TECHNICAL FIELD OF THE INVENTION

The invention relates to electric field-enhancing devices to enhance optical processes in samples in the proximity of the device. In particular, the invention relates to design and fabrication of field-enhancing devices for linear and nonlinear microscopy and spectroscopy applications in physics, chemistry, biology, bioimaging and medical diagnostics field, for example.

### BACKGROUND OF THE INVENTION

Many optical measurement techniques are nowadays used to image or characterize materials, structures, cells and tissue in physics, chemistry and biology. In many of these techniques the sample to be studied is placed on the surface of a suitable substrate material. Many techniques also use light with known properties, such as laser light with a defined wavelength. To advance the state of the art in these case, the substrate on which the sample is placed, could contain some functionality to enhance the measurement process.

The optical processes that these measurements rely on include of fluorescence, multiphoton fluorescence, total internal reflection, second harmonic generation (SHG), sum frequency generation (SFG), two photon excited fluorescence (TPEF) and processes based on interaction with the molecular vibrations, like Raman scattering (RS), linear and nonlinear surface enhanced Raman scattering (SERS), coherent anti-Stokes Raman scattering (CARS) and surface enhanced coherent anti-Stokes Raman scattering (SECARS), tip enhanced Raman scattering (TERS), Stimulated Raman scattering (SRS).

Nonlinear imaging techniques such as CARS microscopy technique was developed for label-free lipid imaging. CARS is based on focused excitation of the vibrational frequency of C—H bonds that are highly abundant in lipids. At the moment, CARS microscopy enables visualization of only massive lipid deposition in cells. However, biologically often more interesting, smaller and dynamic deposits (such as those in forming or regressing lipid droplets or in endosomal organelles) cannot be resolved due to lack of sensitivity. Thus, improving sensitivity in lipid imaging is very important to e.g. understand the progression of diseases.

Fluorescence microscopy is one the most widely used imaging methods in biology by means of its molecular and chemical specificity. The fluorescence microscope is based on the phenomenon that certain materials, for example fluorophores or dyes have large absorption cross-sections at a specific wavelength and emit light at a longer wavelength when irradiated with the light of a specific wavelength. The basic principle is to irradiate the specimen with the desired wavelength and then to separate the much weaker emitted (fluorescent) light from the excitation light. The fluorescent species-labeled molecules are very bright and distinguishable in fluorescence microscopy imaging. Improving fluorescence sensitivity all the way to the limit of single-molecular detection needed in many applications remains, however, a great challenge.

However, the spatial resolution of light microscopy is limited by diffraction of light to several hundred nanometers. This is critical because within cells, the units of life, biomolecules are of nanometer scale. In addition, in cells biomolecules typically exist at low, i.e. nanomolar, concentration, requiring high sensitivity for detection. To overcome the limit, super-resolved fluorescence microscopy was developed by manipulate light at nanoscale.

In prior art methods, even in super-resolved fluorescence microscopy light with high intensity is directed onto a sample which is placed on a coverslip glass. A drawback of the present methods for optical bioimaging is lack of sensitivity to see details of cells. Presently, confocal microscopes provide lateral and depth resolutions of 220 and 520 nm, respectively. However, when zooming into the cells or tissues, where essentially all molecules and a large fraction of subcellular organelles are smaller than this lateral and depth resolution, it becomes an obstacle for visualizing these structures in detail.

### SUMMARY OF THE INVENTION

An object of the invention is to alleviate and eliminate the problems relating to the known prior art. Especially the object of the invention is to provide a device that enhances electric field at the surface or in the proximity of the device. This enhancement is advantageous in various microscopic and spectroscopic measurements. Especially it is advantageous when using light on certain frequencies, such as narrow frequency band LED light and laser light that utilize laser light to excite optical processes in samples lying on or in the proximity of the surface of the device. In addition the object is to avoid disturbing background signals and at the same time also enable large laser powers to be used without a significant risk to damaging the device, such as evaporating the structure material of the nanostructured device. The object advantageously may also allow use of lower light intensities to reach clear images while limiting the heating of the device and the sample being investigated that can be advantageous especially in some areas of biological microscopy. In particular, object of the invention is to provide and develop the field-enhancing device, which is suitable for microscopy linear and nonlinear spectroscopy, and particularly for laser-based microscopy and spectroscopy.

The object of the invention can be achieved by the features of independent claims.

The invention relates to a field-enhancing device to enhance optical processes in samples in the proximity of the device according to claim 1. In addition the invention relates to a manufacturing method for manufacturing the field-enhancing device according to claim 50.

According to embodiments of the invention, fluorescence detection to the limit of sensitivity is improved by controlling the local electromagnetic (EM) field environment of the fluorophores. Plasmonic surfaces or nanostructures have been used to enhance the optical processes where EM fields are of importance. In particular, for instance, the design of nanostructured surfaces to control the local electromagnetic field according to the invention may enhance the emitted fluorescent light. The previous attempt to enhance the intensity of fluorescence microscopy, metallic mirror surface, metal-dielectric multilayer and various nanostructures have been demonstrated. In the embodiments of the invention, metal-insulator-metal (MIM) multilayer with a nanostructured metal or dielectric composed of nanograting is shown to enhance the signal in optical microscopy.

According to an embodiment of the invention the field-enhancing device can be constructed in several ways, but it advantageously comprises at least one metal layer (005) or a metal grating (006) consisting of metal stripes. Usually the device is constructed on some foreign substrate (001). The adhesive layer is advantageous especially when the next layer is metallic, but may not be needed with dielectric layers. The next layers to be constructed form a mirror structure that can also be omitted for simple device constructs. The mirror structure can be either a metal mirror structure or a distributed Bragg reflector structure (DBR). The next layer is the thin metal layer. This layer can be covered with a 1-D metal grating consisting of metal stripes or with a dielectric grating having similar geometry. The structure can also be fabricated without metals when dielectric grating is used as the field-enhancing part. Finally, a protective layer can be added on top of the structure.

The operation of the device is based on advantageous formation of either surface plasmon-polaritons in the metal grating or Tamm plasmon-polaritons in the metal layer when a mirror structure is inserted below. In an advantageous embodiment of the invention, the thicknesses of the layers and the dimensions of the grating are designed to enhance the electric field on the surface of the device when laser light with a known wavelength is directed to the device.

According to an embodiment the metal grating (006) of the device (100) comprises elongated metal stripes and elongated empty spacing or grooves between the stripes. When the plasmonic structure is the metal layer (005), the device may additionally comprise also a dielectric grating (007). The dielectric grating (007) may comprise elongated dielectric stripes and elongated empty spacing or grooves between the stripes. The total number of alternating dielectric layers (0041, 0042) in the DBR mirror structure (004) is advantageously in the range of 2-50.

As an example, the thickness of the underlying substrate (001) is in the range of 50 μm-5 mm, and the thickness of the adhesion layer (002) is in the range of about 0.5-50 nm. The thicknesses of the metal mirror structure (003) are advantageously in the range of 10 nm-500 nm for the metal layer (0031) and in the range of 50 nm-10 μm for the dielectric layer (0032). In addition the thicknesses of the alternating dielectric layers of the DBR mirror structure (004) are advantageously in the range of 10 nm-500 nm for the dielectric layer (0041) and in the range of 10 nm-500 nm for the dielectric layer (0042). Further the thickness of the full metal layer (005) is advantageously in the range of 1 nm-100 nm, and the thickness of the metal layer for the metal grating (006) is advantageously in the range of 5-500 nm. Furthermore the width (0061) of the elongated metal stripes in the metal grating (006) is advantageously in the range of 10-1000 nm, and the empty spacing or grooves (0062) between the two adjacent elongated metal stripes in the metal grating (006) is in the range of 10-1000 nm.

In an advantageous embodiment, the thickness of the full metal layer (005) is at least 40 nm. This thickness of the full metal layer (005) may ensure that in use case scenarios where the device is utilized in connection with a laser, the full metal layer (005) may not evaporate.

According to an example a periodicity (0063) of the adjacent elongated metal stripes in the metal grating (006) comprises the sum of the width (0061) of one elongated metal stripe and the width (0062) of the empty spacing or grooves of two adjacent elongated metal stripes. The periodicity (0063) is advantageously selected to resonate with either the molecular vibrational frequency of a substance in the sample or the frequency of the exciting laser light or both of them. Additionally or in combination, the periodicity is selected to resonate with the absorption/emission wavelength of fluorescent dye or fluorophore or both of them. As an example the periodicity (0063) in the metal grating (006) is advantageously in the range of 10-1000 nm.

According to an example the thickness of the dielectric layer for the dielectric grating (007) is in the range of 5-500 nm. The width (0071) of the elongated dielectric stripes in the dielectric grating (007) is advantageously in the range of 10-1000 nm. In addition the empty spacing or grooves (0072) between the two adjacent elongated dielectric stripes in the dielectric grating (007) is advantageously in the range of 10-1000 nm.

According to an example a periodicity (0073) of the empty spacing or grooves (0072) between the two adjacent elongated dielectric stripes in the dielectric grating (007) comprises the sum of the width (0071) of one elongated dielectric stripe and the width (0072) of the empty spacing of two adjacent elongated dielectric stripes. The periodicity (0073) is advantageously selected to resonate with either the molecular vibrational frequency of a substance in the sample or the frequency of the exciting laser light or both of them. Additionally or in combination, the periodicity is selected to resonate with the absorption/emission wavelength of fluorescent die or fluorophore or both of them. Alternatively or in addition, the widths of the dielectric stripes (0071) and the empty space (0072) between them are designed so that the electric field distribution is as uniform as possible to provide the advantageous enhancement uniformly over the surface. As an example the periodicity (0073) in the dielectric grating (007) is advantageously in the range of 10-1000 nm.

In addition, according to an embodiment the device (100) comprises a protective layer (008). The thickness of the protective layer (008) is advantageously in the range of 1 nm-500.

According to embodiment the substrate (001) of the field-enhancing device (100) comprises for example coverslip glass, normal glass, calcium fluoride (CaF₂), silicon, quarz. In addition according to embodiments the adhesion layer (002) is deposited using materials, such as chromium, titanium and TiO₂. Still in addition the metal mirror (003) of the device (100) comprises an underlying metal layer (0031) that can be any light reflecting metal material, such as gold, silver, aluminium, or copper. The metal mirror layer (0031) is advantageously separated from the field-enhancing structure (005-007) by a dielectric layer (0032) comprising any dielectric material, such as Al₂O₃, TiO₂, SiO₂. The dielectric layers (0041, 0042) of the DBR mirror (004) structure may be any dielectric materials having dissimilar dielectric constants ε₁ and ε₂, such as Al₂O₃, TiO₂, or SiO₂.

According to embodiments the full metal layer (005) and/or the metal grating (006) comprises any plasmonic materials, such as gold, silver, copper, platinum, palladium, aluminium, or any other material which enhances the optical processes. In addition the dielectric grating (007) comprises advantageously any dielectric materials, such as Al₂O₃, TiO₂, SiO₂. Furthermore the protective layer (008) comprises advantageously any dielectric materials, such as Al₂O₃, TiO₂, SiO₂.

The field-enhancing structure described here comprises advantageously nanostructures, such as layers and/or predefined continuous shapes and patterns, such as grooves, for enhancing four wave mixing (FWM) signal intensity without two photon excited luminescence (TPEL) background in SECARS imaging. If the pump frequency of CARS is in resonance with the collective modes of the plasmonic nanostructure, the surface-enhanced CARS (SECARS) signal from molecules absorbed onto the nanostructure will be further enhanced by the local fields of the excited plasmon modes.

According to an example the spacing between the two adjacent elongated grooves is advantageously in the range of about 10-1000 nm. The continuous shape and patterns can be described by a periodicity (periodicity of the two adjacent elongated grooves), which comprises the width of the two adjacent elongated grooves and the spacing of the two adjacent elongated grooves. The periodicity is selected to resonate with the molecular vibrational frequency and/or excited laser light frequency, fluorescent dye or fluorophore and the structure is manufactured so that the periodicity fulfils the formula:

$${λ}_{S P ( i , j )} = \sqrt{\frac{{ɛ}_{d} {ɛ}_{m}}{{ɛ}_{d} + {ɛ}_{m}}} \frac{P}{\sqrt{{i}^{2} + {j}^{2}}} ,$$

where λ_{SP (i,j)} is the resonance wavelength, the integers (i, j) represent the Bragg resonance orders, and ε_{d} and εₘ are the dielectric functions of the metal/dielectric and the measurement medium, respectively.

According to embodiments of the invention the field-enhancing device described in this document is therefore configured to enhance the optical processes of Raman scattering (RS), linear and nonlinear surface enhanced Raman scattering (SERS), coherent anti-Stokes Raman scattering (CARS) and surface enhanced coherent anti-Stokes Raman scattering (SECARS). In addition the device is configured to enhance the optical processes of fluorescence, multiphoton fluorescence, total internal reflection, second harmonic generation (SHG), sum frequency generation (SFG), and two photon excited fluorescence (TPEF).

The structure and dimensions and thicknesses of the nanostructures of the field-enhancing device according to embodiments of the present invention offers clear advantages over the known prior art, namely for example the disturbing background signals especially in FWM or CARS imaging of nano-sized features can be avoided. In addition, due to spacing between the two adjacent elongated grooves or other features as well as other dimensions, the material of the field-enhancing device does not evaporate even with relative strong pulsed laser powers, which is the problem especially with the nanohole structures or nanoantennas in the prior art.

The field-enhancing device according to the present invention can be manufactured for example by providing a plasmonic structure (005, 006) comprising a full metal layer (005) and/or a metal grating (006) on a substrate layer (001) using electron beam lithography (EBL) or nanoimprint lithography (NIL) techniques and lift-off or wet or dry etching process.

The present invention offers advantages over the known prior art. The nanostructured devices according to the invention have a predefined shape or dimensions, arrangement and pattern which results in the strong enhancement of a number of optical phenomena, such as reflectance, absorption, extraordinary optical transmission, linear and nonlinear Raman scattering processes, FWM, SHG, SFG, TPEL and other optical effects. The present invention relates to the SP nanostructures optical resonance phenomena with the excited laser light wavelength and molecular vibrational frequency for strong enhancement of linear and nonlinear Raman scattering processes and fluorescent dye or fluorophores.

Upon laser irradiation of metallic nanostructures for example in nanohole and nanoantenna structures, electromagnetic energy is absorbed and dissipated as heat and it evaporates the nanostructures. The smallest nanostructures have the maximum surface heat or temperature, where the evaporation is largest. The surface plasmon resonance of the smallest nanostructures coincides with excited heating laser wavelength. In the devices according to the present invention the absorption of the electromagnetic energy is smaller and thus it produces very less or negligible heat. This is especially due to the geometry (elongated grooves length are long), but also the thickness of the underlying layers contributes this advantage.

The improvement of signal sensitivity can be achieved in coherent nonlinear optical processes so that the signal sensitivity of CARS is now high enough to visualize also nano-sized features in sample.

The surface enhanced biomedical imaging (SEBI) substrates embodiments of the invention are directed to nanostructures and multilayers comprising metal and dielectrics on coverslip glasses having predefined thicknesses, arrangement and pattern results in high signal sensitivity in the optical imaging. In the surface enhanced biomedical imaging (SEBI) substrates, the surface-enhanced signal from molecules adsorbed onto the nanostructure or multilayers will be enhanced by the local fields of the excited plasmon modes or diffraction gratings. With such an approach, biomolecules can be detected in a multicomponent system at low (nM) concentrations. According to the current invention the SEBI substrates can be used to image the smaller biomolecules in the cells and tissues at nanoscale resolution. Thus, improving the sensitivity in imaging is very important to understand the diseases diagnosis, prevention, drug development, basic research and health monitoring. Especially, the SEBI substrates can be utilized in blue/green fluorescent imaging. The SEBI substrates require low laser power which avoids unwanted heating in cells or tissues.

It has been observed by the inventors that by engineering the surface on which e.g. biomaterials are mounted, it is possible to enhance the signal sensitivity e.g. ˜100-fold compared to the plain coverslip glass.

In particular the present invention is directed to nanostructured features having nanoscale dimensions at predetermined locations on a substrate for linear and nonlinear microscopy techniques such as SERS, SECARS and SRS. The methods and devices disclosed herein allow the fabrication of SERS and SECARS-active structures, including nanoscale dimensions having well defined size, shape and location, which allows for improved signal enhancement of the linear and nonlinear Raman scattering based techniques such as spontaneous Raman, SERS, CARS and SRS.

Particularly, the optical processes comprise linear and nonlinear surface enhanced Raman scattering (SERS) and surface enhanced coherent anti-Stokes Raman scattering (SECARS) spectroscopy. In addition it is to be noted that the field-enhancing device is also configured and suitable for second harmonic generation (SHG), sum frequency generation (SFG) fluorescence and two photon excited fluorescence (TPEF) spectroscopy.

The detection e.g., identification and molecular imaging of different chemical and biological composition species inside a sample with nano-sized features sensitivity using CARS spectroscopy has not been performed before. The detection and visualization of the plasma membrane has remained a challenge. The embodiments of the present invention address these problems in the current state of the art and potential applications in biology, bioimaging, medical diagnostic, pathology, toxicology, forensics, cosmetics, chemical analysis and numerous other fields.

The SEBI substrates may improve the understanding of the role of biomolecules in cells and tissues for progression and regression of diseases. The SEBI substrates may pave the way for future biomedical imaging that is essential for early detection and monitoring.

Especially the device illustrated in different embodiments of the invention is useful in imaging such as fluorescence, SECARS, where it may be useful to manipulate certain wavelengths (such as laser wavelength, and the fluorescence output wavelengths). In addition it may be useful in spectroscopy, imaging, fields of physics, chemistry and biology for enhancing imaging sensitivity and/or or quality (images and/or video), and ability to adjust the optical properties for specific wavelengths (e.g. resonance at certain wavelength area), for example. The material selection as well as their dimensions and possible shapes have an effect to the resonance (which wavelengths are effected in which way) and they can be used for optimizing the device of the invention for specific purposes.

Through embodiments of the invention, further benefits related to may also be achieved, such as obtaining a high number of frames in spectroscopy, low or slow bleaching of fluorescence, longer imaging times, advantageous Fluorescence Recovery After Photobleaching (FRAP), and/or high endurance and higher cell adhesion or growth.

The device of the invention provides advantages over the prior art devices. At first the invention provides a device with adjustable optical properties. The device is based on either plasmonic effect or diffraction and interference in the case of dielectric gratings, and comprises a substrate, and at least one or more additional layers of materials. The substrate may be glass or other transparent material, and the other layer advantageously comprises metal and/or dielectric layers, preferably the layers may be Ag/Au/AI and/or TiO₂/Al₂O₃/SiO₂. In addition the device may comprise nanostructures preferably on the top layer.

The device according to the embodiments uses advantageously surface plasmon or TAMM plasmon phenomena and/or diffraction and interference, having effect advantageously in the near field of the surface. The device advantageously enhances the features that are close to the device typically from 10 nm to 1 μm from the surface of the device. The device may alternatively or in addition advantageously use diffraction grating effect that can also extend a longer distance from the surface of the device.

According to an embodiment the device may be implemented e.g. on a coverslip glass that can be inserted in a microscope in place of a current coverslip glass, suitable for use for example in laser microscopy. The device is preferably designed so that light is shown and collected from the top side of the device, where also the sample to be imaged is located (not for example light coming from below).

In embodiments of the invention, the devices/SEBI substrates may be constructed so that a depth of a grating is considered. The depth may be varied to change an angle of incidence so that a resonance wavelength of a plasmonic wave may be changed. The depth of a grating associated with a device may e.g. be tailored to a specific use.

A thickness of a protective layer which may be used in some embodiments of the invention may also be tailored for a specific use case scenario, as the thickness of the protective layer may also shift a resonance wavelength of a plasmonic wave.

In one embodiment of the invention, the SEBI substrate may be optimized for green fluorescent protein (GFP).

Further embodiments of the invention may provide SEBI substrates that are optimized for e.g. other proteins, such as mCherry.

The exemplary embodiments presented in this text are not to be interpreted to pose limitations to the applicability of the appended claims. The verb “to comprise” is used in this text as an open limitation that does not exclude the existence of also unrecited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objects and advantages thereof, will be best understood from the following description of specific example embodiments when read in connection with the accompanying drawings.

### BRIEF DESCRIPTION OF THE DRAWINGS

Next the invention will be described in greater detail with reference to exemplary embodiments in accordance with the accompanying drawings, in which:

FIG. 1 illustrates exemplary constituting parts of the device according to an advantageous embodiment of the invention,

FIG. 2 illustrates the structure of nanogratings according to an advantageous embodiment of the invention

FIG. 3 illustrates three different examples of devices according to an advantageous embodiment of the invention,

FIG. 4 illustrates exemplary reflectance measurements,

FIG. 5 illustrates exemplary reflectance spectra of the exemplary device according to an advantageous embodiment of the invention,

FIG. 6 illustrates example of calculated transverse magnetic (TM) and transverse electric (TE) reflectance spectra of a device according to an advantageous embodiment of the invention,

FIG. 7 shows one exemplary structure of a device according to an embodiment of the invention where the SEBI substrate is optimized for green fluorescent protein (GFP),

FIG. 8 illustrates a reflectance spectrum that may be obtained with a device according to the embodiment of FIG. 7,

FIG. 9 gives one more exemplary structure of a device according to an embodiment of the invention,

FIG. 10 illustrates yet one exemplary structure of a device according to an embodiment of the invention,

FIG. 11 shows a reflectance spectrum that may be obtained with a device according to the embodiment of FIG. 9, and

FIG. 12 shows a reflectance spectrum that may be obtained with a device according to the embodiment of FIG. 10.

### DETAILED DESCRIPTION

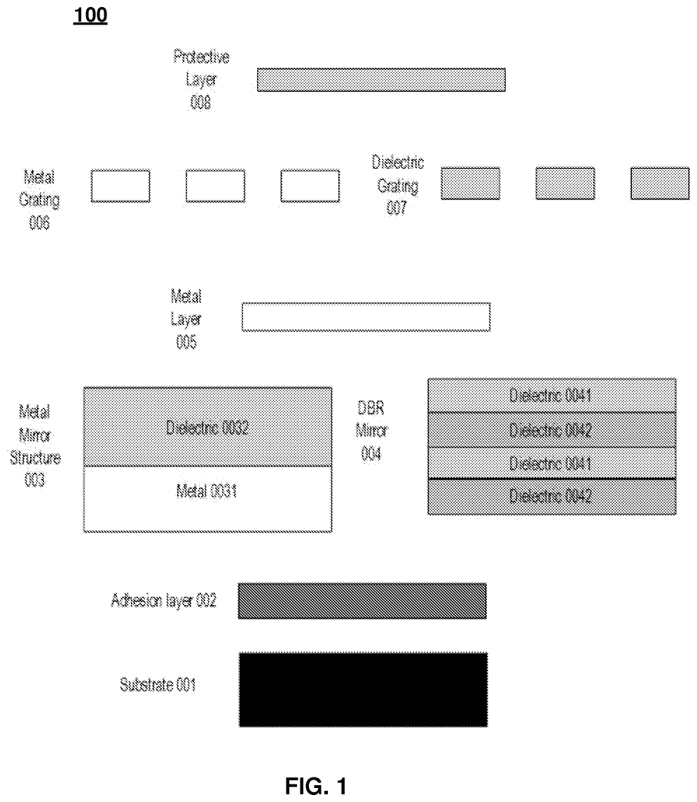

The different embodiments of field-enhancing devices according to the invention is next described by referring to FIGS. 1-6.

According to an embodiment of the invention the field-enhancing device (100) can be constructed in several ways, but it always contains at least one metal layer (005) or a metal or dielectric grating (006, 007) consisting of metallic or dielectric stripes. Usually the device is constructed on some foreign substrate (001). The adhesive layer (002) is advantageous when the next layer is metallic, but may not be needed with dielectric layers. The next layers to be constructed form a mirror structure, that can also be omitted for simple device constructs. The mirror structure can be either a metal mirror structure (003) or a distributed Bragg reflector structure (DBR) (004). The next layer is the thin metal layer (005), that can also be omitted. This layer can be covered with a 1-D metal grating (006) consisting of metal stripes or with a dielectric grating (007) having similar geometry. Finally, a protective layer (008) can be added on top of the structure.

The object of the invention is a device that enhances electric field at the surface and in the proximity of the device. This enhancement is advantageous in certain microscopic and spectroscopic measurements that utilize laser light to excite optical processes in samples lying on the surface of the device.

The function of the device is based on excitation of surface plasmon-polaritons (SPPs) or Tamm plasmons (TPs) at the interface of a metal and a dielectric. Also diffraction grating effect can enhance the field when dielectric grating is used on the surface. These excitations provide a much enhanced electric field at the surface of the device when light is focused on it compared to the situation that light is focused on, e.g., a glass surface only. The device is advantageously designed so that the incoming light and the dimensions of the device are at resonance.

FIG. 1 shows the constituting parts of the device; some of which are optional and can be omitted in certain embodiments, as is described elsewhere in this document. With these parts several different configurations can be designed leading to multitude device constructs that provide the advantageous enhancement of the electric field.

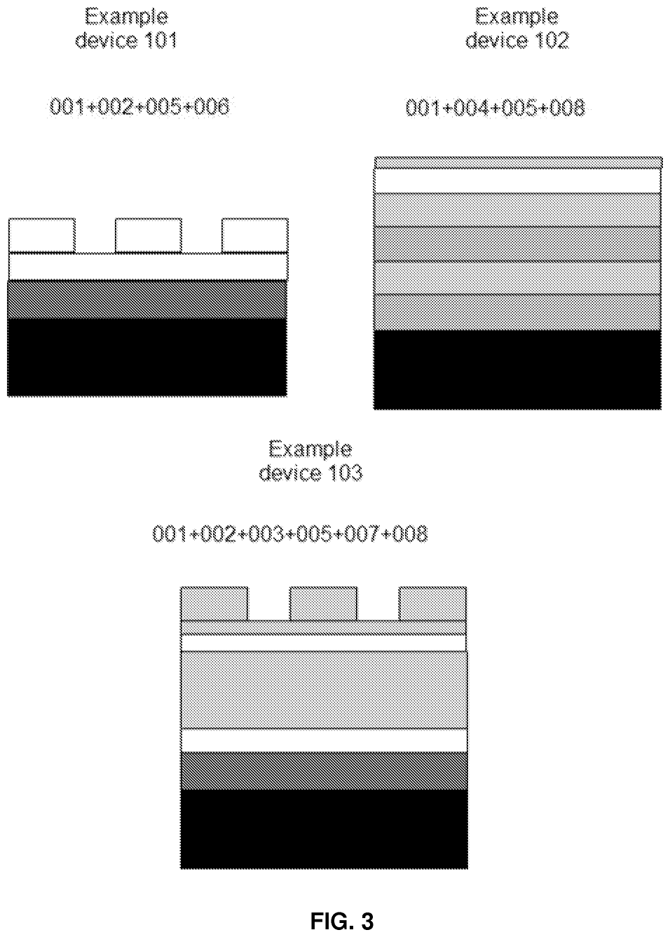

FIG. 3 shows three different examples of devices that can be constructed.

The field-enhancing device (100) consists of a substrate (001) on which the device is manufactured, an optional adhesion layer (002), an optional mirror structure (003, 004), that can be either a metal mirror structure (003) or a distributed Bragg reflector (DBR) mirror structure (004), the plasmonic structure (005, 006) comprising a full metal layer (005) or a metal grating (006) or both of them in the order of FIG. 1, an optional dielectric grating (007), and finally an optional protective layer (008).

The substrate can be of any material, most typical being coverslip glass or normal glass. The optional adhesion layer (002) is advantageous especially when the next layer is metal. It ensures that the metal layer does not roll away from the substrate and improves heat conduction from the metal. The metal on top of the adhesion layer can be either the metal layer (0031) in the mirror structure (003) or the plasmonic metal layer (005). The adhesion layer can be metal or dielectric, most common being Ti.

When the device (100) utilizes Tamm plasmons, a mirror structure comes next in the build order. There are two options, the metal mirror structure (003) or the DBR structure (004). The metal mirror structure (003) consists of a metal layer (0031) on the bottom and a dielectric layer (0032) on top of it. The thickness of the dielectric layer is chosen so that resonance with the incoming light is achieved. The DBR structure consists of alternating dielectric layers (0041) and (0042) of different materials having different refractive indexes. The number of layers can be any integer above and including two. The most common dielectric materials for the dielectric layers in the device (100) are Al2O3, TiO2 and SiO2, but any dielectric can be used.

When utilizing TPs, a thin full metal layer (005) is fabricated on top of the mirror structure (003/004). This metal and the adjacent dielectric form the interface where the TP is concentrated. The enhanced electric field on the surface can also be achieved by forming a dielectric grating (007) on top of the structure. The grating consists of elongated dielectric stripes (0071) and empty space (0072) between the stripes. The widths of the dielectric stripes (0071) and the empty space (0072) between them are designed so that the electric field distribution is as uniform as possible to provide the advantageous enhancement as uniformly over the surface as possible. With certain metals, the metal layer (005) must be protected, e.g., against oxidation, and then a protective dielectric layer (008) is made on top of the whole structure or it is applied before the dielectric grating (007) is formed.

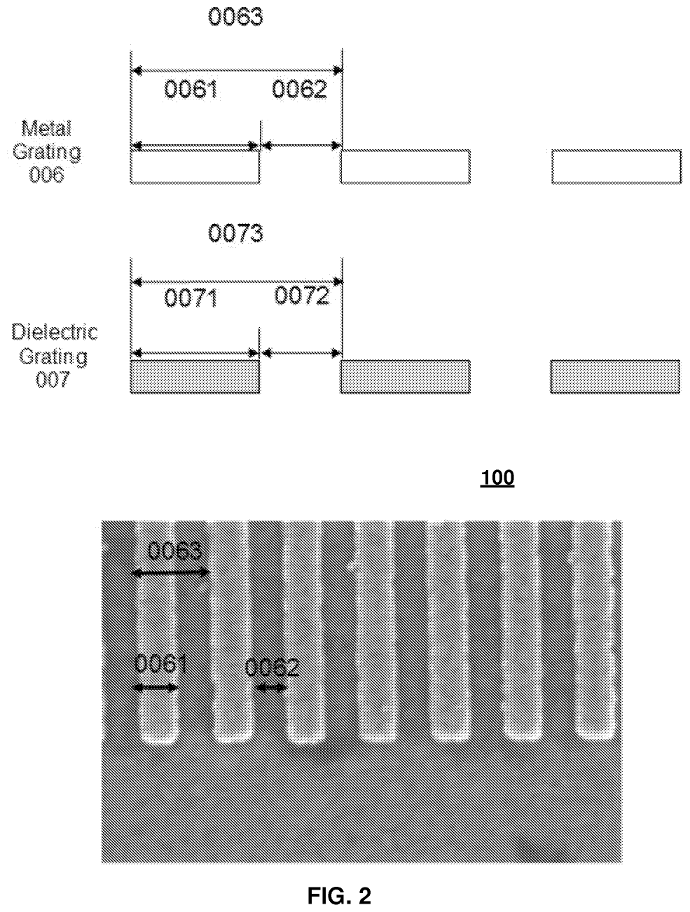

When the device (100) utilizes SPPs, the device usually does not need mirror structures below the metal layer (005), but the adhesive layer (002) may be used on top of the substrate (001). The full metal layer together with the adhesive layer provide better heat conduction to preserve the integrity of the metal grating (006) on top of it. The optional metal grating (006) comprises elongated metal stripes and empty spacing between the stripes. FIG. 2 (top) shows the geometry of the grating from a side profile. The widths of the metal stripes (0061) and the empty space (0062) between them are chosen together with the periodicity (0063) so that the SPPs and the incoming light are at resonance. Again, with certain metals, a protective layer (008) can be used as the topmost layer. The metal materials in the device (100) can be any metals, most common being gold, silver and aluminium. FIG. 2 (bottom) shows a scanning electron microscope image of a fabricated 1-D gold grating.

Three exemplary embodiments of the invention are shown in FIG. 3: the SP version with the metal grating (top left, device 101), the TP version with a DBR mirror (top right, device 102), and the TP version with a metal mirror structure and a dielectric grating (bottom, device 103).

In another advantageous embodiment of the invention the device comprises the substrate, adhesion layer, metal mirror structure with dielectric layer, and a dielectric grating. The device may then also include a protective layer. This embodiment of the device uses diffraction grating effect. The metal mirror may also in this structure be substituted with a DBR mirror. In this case, an additional dielectric layer may also be added between the DBR mirror and the dielectric grating.

Advantageously, this version of the device works with both TE and TM mode laser light.

Various embodiments of the device are well suitable and stable to be adjacent to various media such as water, Phosphate Buffer Solution or cellular tissue culture media.

The components and versions of the device may be combined to achieve the desired effects, for example to achieve increased resonance at one wavelength, or resonance at several different wavelengths.

The most common manufacturing methods of the field-enhancing device (100) are described below, but the device can be constructed also with different manufacturing techniques. The adhesion layer (002), the metal in the mirror (0031), the full metal (005) and the starting layer for the metal grating (006) are typically deposited by a metal evaporator or a sputter. The dielectric layers (0032, 0041, 0042, 008) and the starting layer for the dielectric grating (007) are usually deposited by plasma enhanced chemical vapour deposition (PECVD) or by atomic layer deposition (ALD). For the grating (006, 007) fabrication, the features are typically defined by electron beam lithography (EBL) or nanoimprint lithography (NIL) after which a lift-off processes or dry and wet etching processes is applied.

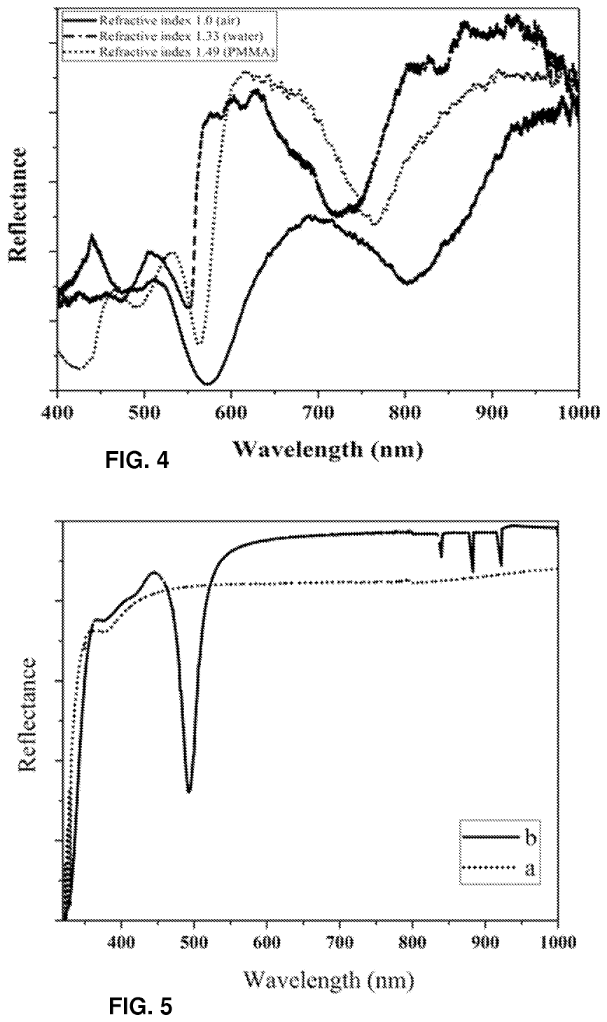

FIG. 4 shows the reflectance measurements of the SP nanograting structure with groove width of 200 nm and spacing of 100 nm on an area of 30×30 pmt. The optical reflectance properties of the SP nanograting structures were characterized with varying refractive indexes of 1 (air), 1.33 (water) and 1.49 (PMMA). The incident TM polarized light was illuminated along the 1-D nanograting structure and the reflected light was collected by the optical spectrometer. The measurement spectra show the surface plasmon resonance wavelengths with respect to the predefined 1-D nanograting structures. The decreased reflectance (i.e., increased absorption) at resonance (based on the dimensions of the grating and the refractive index of the environment) shows the effectiveness of the structure. This present invention relates to the use of nanograting structures as disclosed herein to resonate with the excited laser beam and molecular vibrational frequency for enhancing linear and nonlinear Raman scattering, TPEL, SHG, SFG and FWM signal intensity.

FIG. 5 illustrates the reflectance spectra of the exemplary device 102. The reflectance spectrum of the mirror structure 004 only (curve a) shows high reflectance from 350 to 1000 nm. When the whole device 102 is measured (curve b), the characteristic reflection minimum or absorption dip related to the plasmons can be clearly seen at the designed wavelength. This wavelength can be varied over a wide range by changing the dimensions in the structure.

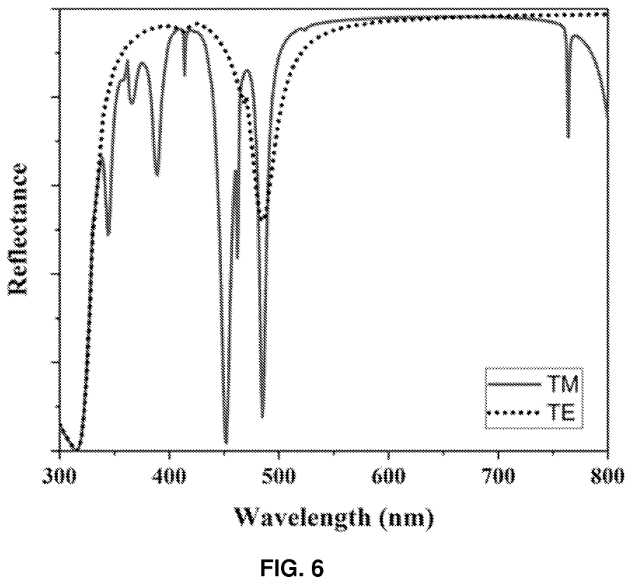

FIG. 6 illustrates the calculated transverse magnetic (TM) and transverse electric (TE) reflectance spectra of a device 100 construct, that uses Tamm plasmons, surface plasmons and grating diffraction that are coupled to achieve high signal amplification. As seen from the figure, this device can be used in both TM and TE modes in microscopes. The absorption dip wavelength is between 450 to 500 nm.

The nonlinear coherent emissions of FWM, TPEL, SHG and SFG signal intensities are significantly enhanced by using SP nanostructured nanograting grooves according to embodiment of the present invention. The present invention can be used in biological, bioimaging, medical diagnosis, pathology and chemical applications where it is useful to detect and identify the small number of molecules in sample

The resonance frequency of the TAMM plasmon may be adjusted by the thickness of the metal and dielectric layers of the device.

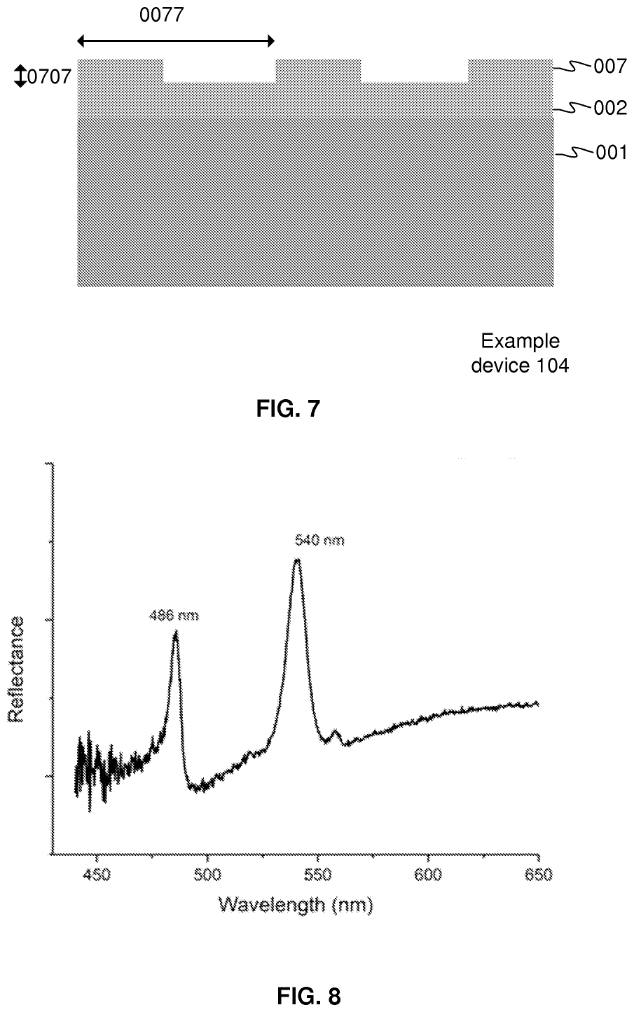

FIG. 7 shows one exemplary structure of a device 104 according to an embodiment of the invention where the SEBI substrate is optimized for green fluorescent protein (GFP). The structure depicted may be used for fixed or live cells.

The periodicity 0077 defines the surface plasmon resonance wavelength of the grating structure. The periodicity 0077 may be varied from 250 to 350 nm to resonate with the green fluorescent protein (GFP) excitation wavelength, which is at 488 nm. In an advantageous embodiment, the periodicity 0077 is around 300 nm.

The depth 0707 (essentially corresponding to the depth of the grating) determines the strength of the resonance wavelength. The value of the depth 0700 may be between 20-60 nm. In an advantageous embodiment, the depth 0707 is about 20 nm.

In the embodiment of FIG. 7, the device comprises a substrate 001, which may in this specific exemplary embodiment glass. With a glass substrate, the device may be used in both reflection and transmission mode.

An adhesion layer (002) may in FIG. 7 comprise TiO₂, while a dielectric grating (007) may also comprise TiO₂. The thickness of the adhesion layer (002) may be 20-150 nm, advantageously 69 nm. A total thickness of the device may be around 89 nm. The structure may be optimized to operate in the region of green light and may thus be advantageous with GFP.

The adhesion layer (002) of TiO₂ may be deposited by atomic layer deposition (ALD) method. The dielectric grating may be formed by electron beam lithography or nanoimprint lithography techniques.

FIG. 8 shows the reflectance spectrum that may be obtained with a device according to the embodiment of FIG. 7. Diffraction peaks may be observed at 484 nm and 540 nm (measured in water, refractive index 1.33).

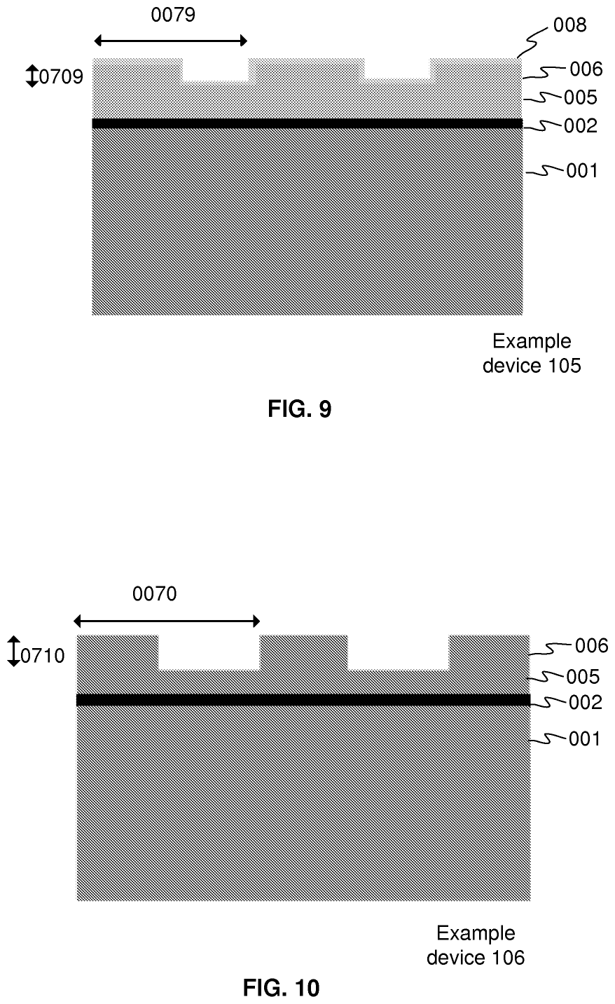

FIG. 9 gives one more exemplary structure of a device (105) according to an embodiment of the invention where the SEBI substrate is optimized for GFP. The periodicity (0079) of the grating may be varied from 250-350 nm to resonate with the green GFP excitation wavelength. In an embodiment, the periodicity (0079) is 300 nm. The structure of FIG. 9 may be used with fixed or live cells, and may be used in reflection mode. Here, the excitation and emission may be collected from the same direction.

The depth (0709) of the grating may be between 20-60 nm and advantageously a depth of about 25 nm may be used.

A substrate 001 may be glass or silicon, advantageously silicon, while an adhesion layer (002) may be Ti with a thickness of 2-6 nm, advantageously about 5 nm. A full metal layer (005) may be Ag with a thickness of 50-100 nm, advantageously about 80 nm. A metal grating (006) may be Ag with thickness of 25 nm so as to advantageously form the depth (0709) of 25 nm. A protective layer (008) may be Al₂O₃ with a thickness of 2-10 nm, advantageously about 5 nm.

The titanium adhesion layer (002) and/or the silver metal may be deposited by evaporation or sputter techniques. The protective layer (008) may be deposited by atomic layer deposition. ALD may provide the benefit of providing confocal growth which may be important to avoid the bleaching or quenching effect in fluorescence imaging.

FIG. 10 shows yet one exemplary structure of a device (106) according to an embodiment of the invention, which is optimized for mCherry protein and/or for use with SECARS and is usable mainly in the infrared region. The periodicity (0710) of the grating may be varied from 500-600 nm to resonate with the red fluorescent protein excitation wavelength, which is at 561 nm. In an embodiment, the periodicity (0710) is about 580 nm. The structure of FIG. 10 may be used for fixed or live cells, and may be used in reflection mode. Also here, the excitation and emission may be collected from the same direction.

A substrate (001) may be glass or silicon, advantageously silicon. An adhesion layer (002) may be Ti with a thickness between 2-6 nm, advantageously around 5 nm. A full metal layer (005) may be Au with a thickness of 50-100 nm, advantageously about 80 nm. A metal grating (006) may be Au with thickness of 25 nm so as to advantageously form the depth (0710) of 25 nm.

The adhesion layer (002) may be deposited by evaporation or sputtering techniques. The grating of the metal layer may be formed by electron beam lithography or nanoimprint lithography techniques, while the gold metal may be deposited by evaporation or sputtering. This surface layer quality and roughness values may be important for biomedical imaging applications. The growth and/or deposition parameters may be optimized to achieve high surface quality.

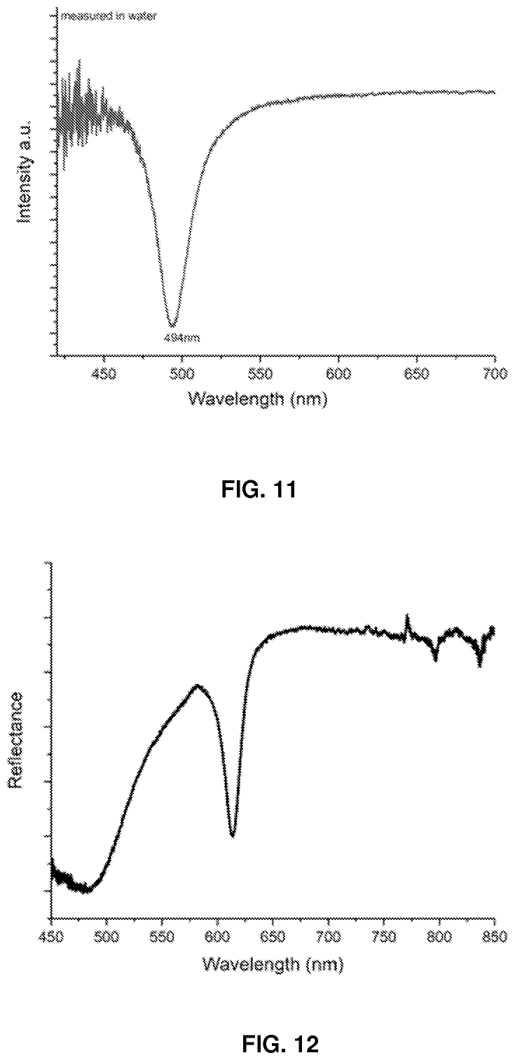

FIG. 11 shows a reflectance spectrum (measured in water, refractive index 1.33) that may be obtained with a device according to the embodiment of FIG. 9. The spectrum shows a surface plasmon dip at 494 nm.

FIG. 12 shows a reflectance spectrum (measured in air, refractive index 1) that may be obtained with a device according to the embodiment of FIG. 10. The spectrum shows a surface plasmon dip at 613 nm.

The invention has been explained above with reference to the aforementioned embodiments, and several advantages of the invention have been demonstrated. It is clear that the invention is not only restricted to these embodiments, but comprises all possible embodiments within the spirit and scope of the inventive thought and the following patent claims.

The features recited in dependent claims are mutually freely combinable unless otherwise explicitly stated.

1. A field-enhancing device to enhance optical processes in samples lying on or in the proximity of a surface of the device, the device comprising:
a substrate,
a field-enhancing structure arranged on the substrate and comprising
dielectric grating, said dielectric grating consisting of dielectric stripes.

2. The device of claim 1, wherein the device comprises additionally an adhesion layer and/or mirror structure, where the mirror structure is a metal mirror structure or a distributed Bragg reflector mirror structure.

3. The device of claim 1, wherein the field-enhancing structure comprises a metal grating, wherein the metal grating of the device comprises elongated metal stripes and elongated empty spacing or grooves between the stripes.

4. The device according to claim 1, wherein the field-enhancing structure comprises a full metal layer and a dielectric grating.

5. The device of claim 4, wherein the dielectric grating of the device comprises elongated dielectric stripes and elongated empty spacing or grooves between the stripes.

6. The device of claim 2, wherein the total number of alternating dielectric layers in the DBR mirror structure is in a range of 2-50.

7. The device of claim 1, wherein the thickness of the underlying substrate is in a range of 50 μm-5 mm.

8. The device of claim 2, wherein the thickness of the adhesion layer is in a range of about 0.5-50 nm.

9. The device of claim 2, wherein the thicknesses of the metal mirror structure are in a range of 10 nm-500 nm for the metal layer and in a range of 50 nm-10 μm for the dielectric layer.

10. The device of claim 6, wherein the thicknesses of the alternating dielectric layers of the DBR mirror structure are in a range of 10 nm-500 nm for the dielectric layer and in a range of 10 nm-500 nm for the dielectric layer.

11. The device of claim 1, wherein the field-enhancing structure comprises a full metal layer and the thickness of the full metal layer is in a range of 1 nm-100 nm, preferably at least 40 nm.

12. The device of claim 1, wherein the field-enhancing structure comprises a metal grating, wherein the thickness of the metal layer for the metal grating is in a range of 5-500 nm.

13. The device of claim 3, wherein the width of the elongated metal stripes in the metal grating is in a range of 10-1000 nm.

14. The device of claim 3, wherein the empty spacing or grooves between the two adjacent elongated metal stripes in the metal grating is in a range of 10-1000 nm.

15. The device of claim 3, wherein a periodicity of the adjacent elongated metal stripes in the metal grating comprises the sum of the width of one elongated metal stripe and the width of the empty spacing or grooves of two adjacent elongated metal stripes, and wherein the periodicity is selected to resonate with either the molecular vibrational frequency of a substance in the sample or the frequency of the exciting laser light or both of them.

16. The device of claim 15, wherein the periodicity in the metal grating is in a range of 10-1000 nm.

17. The device of claim 4, wherein the thickness of the dielectric layer for the dielectric grating is in a range of 5-500 nm.

18. The device of claim 4, wherein the width of the elongated dielectric stripes in the dielectric grating is in a range of 10-1000 nm.

19. The device of claim 4, wherein the empty spacing or grooves between the two adjacent elongated dielectric stripes in the dielectric grating is in a range of 10-1000 nm.

20. The device of claim 4, wherein a periodicity the empty spacing or grooves between the two adjacent elongated dielectric stripes in the dielectric grating comprises the sum of the width of one elongated dielectric stripe and the width of the empty spacing of two adjacent elongated dielectric stripes, and wherein the periodicity is selected to resonate with either the molecular vibrational frequency of a substance in the sample or the frequency of the exciting laser light or both of them.

21. The device of claim 20, wherein the periodicity in the dielectric grating is in a range of 10-1000 nm.

22. The device of claim 1, wherein the device comprises a protective layer, and wherein the thickness of the protective layer is in a range of 1 nm-500 nm.

23. The device of claim 1, wherein the substrate of the device comprises for example coverslip glass, normal glass, calcium fluoride (CaF2), silicon.

24. The device of claim 2, wherein the adhesion layer is deposited using materials, such as chromium, titanium and TiO₂.

25. The device of claim 2, wherein the metal mirror of the device comprises an underlying metal layer, that can be any light reflecting metal material, such as gold, silver, aluminium, or copper.

26. The device of claim 2, wherein the metal mirror layer is separated from the field-enhancing structure by a dielectric layer comprising any dielectric material, such as Al₂O₃, TiO₂, SiO₂.

27. The device of claim 2, wherein the dielectric layers of the DBR mirror structure are any dielectric materials having dissimilar dielectric constants ε₁ and ε₂, such as Al₂O₃, TiO₂, or SiO₂.

28. The device of claim 1, wherein the field-enhancing structure comprises a full metal layer, wherein the full metal layer and/or the metal grating comprises any plasmonic materials, such as gold, silver, copper, platinum, palladium, aluminium, or any other material which enhances the optical processes.

29. The device of claim 4, wherein the dielectric grating comprises any dielectric materials, such as Al₂O₃, TiO₂, SiO₂.

30. The device of claim 22, wherein the protective layer comprises any dielectric materials, such as Al₂O₃, TiO₂, SiO₂.

31. The device of claim 1, wherein the field-enhancing device is configured to enhance the optical processes of Raman scattering (RS), linear and nonlinear surface enhanced Raman scattering (SERS), coherent anti-Stokes Raman scattering (CARS) and surface enhanced coherent anti-Stokes Raman scattering (SECARS).

32. The device of claim 1, wherein the device is configured to enhance the optical processes of fluorescence, second harmonic generation (SHG), sum frequency generation (SFG), and two photon excited fluorescence (TPEF).

33. The device of claim 1, wherein the field-enhancing structure comprises nanograting structures with elongated grooves and comprises predefined continuous shape and patterns for enhancing four wave mixing (FWM) signal intensity without two photon excited luminescence (TPEL) background in SECARS imaging.

34. The device of claim 1, wherein the field-enhancing structure comprises an adhesion layer comprising TiO₂ and a dielectric grating comprising TiO₂.

35. The device of claim 34, wherein a depth of the grating is 20-60 nm, preferably 20 nm.

36. The device of claim 34, wherein a periodicity of the grating is 250-700 nm, preferably 300 nm.

37. The device of claim 34, wherein the thickness of the adhesion layer is 20-150 nm, preferably 69 nm.

38. The device of claim 1, wherein the field-enhancing structure comprises an adhesion layer comprising Ti, a full metal layer comprising Ag, a metal grating comprising Ag, and a protective layer comprising Al₂O₃.

39. The device of claim 38, wherein the wherein a depth of the grating is 20-60 nm, preferably 25 nm.

40. The device of claim 38, wherein a periodicity of the grating is 250-350 nm, preferably 300 nm.

41. The device of claim 38, wherein the thickness of the adhesion layer is 2-6 nm, preferably 5 nm.

42. The device of claim 38, wherein the thickness of the full metal layer is 50-100 nm, preferably 80 nm.

43. The device of claim 38, wherein the thickness of the protective layer is 2-10 nm, preferably 5 nm.

44. The device of claim 1, wherein the field-enhancing structure comprises an adhesion layer comprising Ti, a full metal layer comprising Au, and a metal grating comprising Au.

45. The device of claim 44, wherein a depth of the grating is 20-60 nm, preferably 25 nm.

46. The device of claim 44, wherein a periodicity of the grating is 500-650 nm, preferably 580 nm.

47. The device of claim 44, wherein the thickness of the adhesion layer is 2-6 nm, preferably 5 nm.

48. The device of claim 44, wherein the thickness of the full metal layer is 50-100 nm, preferably 80 nm.

49. A method for manufacturing a field-enhancing device of claim 1, wherein the method comprises steps of:
providing a field-enhancing structure comprising a dielectric grating, said dielectric grating consisting of dielectric stripes, on a substrate layer using electron beam lithography (EBL) or nanoimprint lithography (NIL) techniques and lift-off or wet or dry etching process.

50. The method of claim 49, further comprising fabricating additionally an adhesion layer and/or mirror structure on the field-enhancing device, wherein the mirror structure is a metal mirror structure or a distributed Bragg reflector (DBR) mirror structure.

51. The method of claim 49, wherein the method comprises steps of fabricating the field-enhancing device on a substrate so that the adhesion layer is first deposited by a metal evaporator, followed by fabricating an intermediate layer, and after fabricating at least one adhesion layer and intermediate layer the electron beam lithography or nanoimprint lithography and lift-off processes are applied.

52. The method of claim 49, wherein a periodicity P is the periodicity of the two adjacent elongated grooves and the periodicity P is selected in relation to a wavelength so that λ_{SP (i,j)} the formula:
$${λ}_{SP ( i , j )} = \sqrt{\frac{{ɛ}_{d} {ɛ}_{m}}{{ɛ}_{d} + {ɛ}_{m}}} \frac{P}{\sqrt{{i}^{2} + {j}^{2}}} ,$$
is fulfilled
where the integers (i, j) represent the Bragg resonance orders, and ε_{d} and εₘ are the dielectric functions of the metal and measurement medium, respectively.

53. The device of claim 1, wherein the field-enhancing structure additionally comprises a full metal layer and/or a metal grating.
